(19) United States
(12) Patent Application Publication
(10) Pub. No.: US 2006/0215580 A1
(43) Pub. Date: Sep. 28, 2006

(54) Method and apparatus for monitoring network device

(75) Inventor: Hajime Iinuma, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/169,835

(22) Filed: Jun. 30, 2005

(30) Foreign Application Priority Data
Mar. 23, 2005 (JP) 2005-082880

(51) Int. Cl. H04L 12/28

(52) U.S. Cl. 370/254

(57) ABSTRACT

An apparatus, which provides status information on a status of a target device to a network management system, includes: a request unit that requests the target device to output the status information; and a converting unit that converts a format of the status information output from the target device to another format which can be managed by the network management system.

### BACKGROUND OF THE INVENTION

1. Field of the Invention

The present invention relates to a technology for managing a network device (such as a router) through a protocol other than the simple network management protocol (SNMP).

2. Description of the Related Art

Conventionally, for monitoring an internet protocol (IP) network, a network management system (NMS) obtains necessary information from a management information base (MIB) of each device in the network (such as a router) using the simple network management protocol (SNMP).

However, the NMS cannot access the device that does not have any unused IP port for SNMP communication (such as RJ45), and therefore cannot monitor the IP network including such a device.

FIG. 1 is a diagram for explaining the above problem in the conventional technology. A network management system (NMS) 100 can access the MIB information of routers 300a and 300b that are connected to the NMS 100 via an IP network. However, the NMS 100 cannot communicate with a router 300c using IP or SNMP, since the router 300c does not have any unused port for connecting to the IP network or to the NMS 100. As a result, monitoring cannot be performed.

As for a device not supporting SNMP (hereinafter, “non-SNMP device”), it has been suggested to assign a temporary IP address and host name to the non-SNMP device, collect the status of the non-SNMP device by receiving a trap message via a proxy agent, and display the host name of the non-SNMP device (see, Japanese Patent Application Laid-Open No. H10-4407).

### SUMMARY OF THE INVENTION

An apparatus according to an aspect of the present invention, which provides status information on a status of a target device to a network management system, includes: a request unit that requests the target device to output the status information; and a converting unit that converts a format of the status information output from the target device to another format which can be managed by the network management system.

A method according to another aspect of the present invention, which is a method for providing status information on a status of a target device to a network management system, includes: requesting the target device to output the status information; and converting a format of the status information output from the target device to another format which can be managed by the network management system.

A computer-readable recording medium according to still another aspect of the present invention stores a computer program that causes a computer, which provides status information on a status of a target device to a network management system, to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining a problem in a conventional technology;

FIG. 2 is a block diagram of a network including a proxy device according to an embodiment of the present invention;

FIG. 3 is an outside view of a router connected to the proxy device;

FIG. 4 is a block diagram of the proxy device;

FIG. 5 is a flowchart of a collection of status information;

FIG. 6 is a flowchart of a conversion of the status information;

FIG. 7 is a flowchart of a notification of a change in the status information;

FIG. 8 is a schematic diagram of a command database;

FIG. 9 is a schematic diagram of a definition file;

FIG. 10 is a schematic diagram of the status information; and

FIG. 11 is a schematic diagram of the status information converted to the MIB format.

### DETAILED DESCRIPTION OF THE PREFERRED EMBODIMENTS

Exemplary embodiments of the present invention are explained below in detail with reference to the accompanying drawings.

Some network devices (such as routers) include, other than the IP port, a serial port for TELNET communication (such as RS-232C port/COM port). Furthermore, some network devices output status information in response to a predetermined command.

Therefore, in the present invention, a proxy device is arranged between the NMS and the network device to be monitored. The proxy device requests the network device to output status information, converts the format of the status information to a format that can be referred to by the NMS (such as the MIB format), and stores the converted status information.

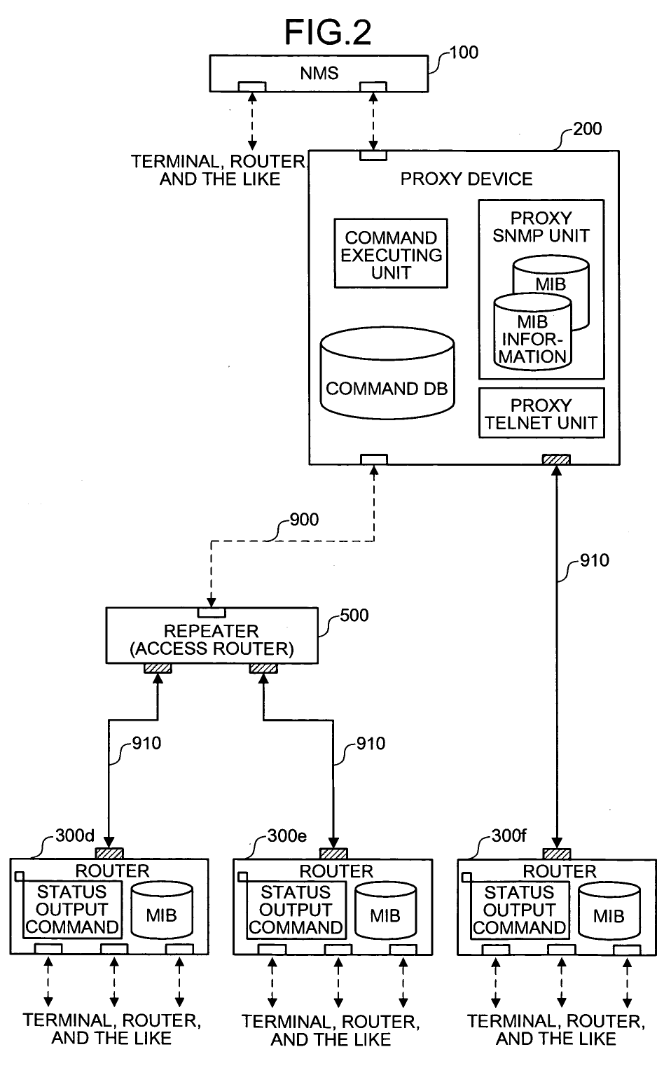

FIG. 2 is a block diagram of a network including the proxy device according to an embodiment of the present invention. A dotted line 900 represents an IP network, and a solid line 910 represents a serial line.

A network management system (NMS) 100 is connected to a proxy device 200 via the IP network. The NMS 100 accesses the management-information-base (MIB) information stored in the proxy device 200 using SNMP.

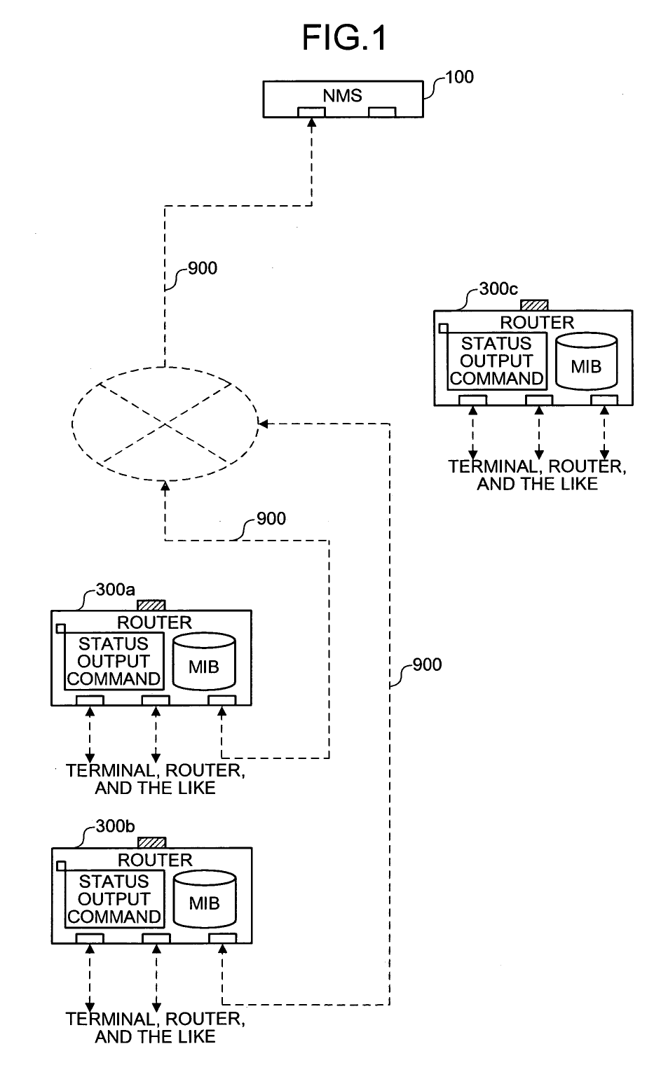

The NMS 100 may be directly connected to the router 300 (in other words, not via the proxy device 200 as shown in FIG. 1), to access the MIB information of the router 300 directly.

The MIB information described in the present embodiment refers to MIB or MIB-II, which is transmitted to inform an external device of the status of the own device. MIB is defined as RFC1156 and MIB-II is defined as RFC1213.

The proxy device 200 is arranged between the NMS 100 and the network device to be monitored by the NMS 100, that is, routers 300d to 300f.

The proxy device 200 is realized by providing the following respective units to a general personal computer, workstation, or server apparatus, or by storing a program for making a personal computer, workstation, or a server apparatus function as the respective units, or by reading the program via a portable recording medium or a network.

The proxy device 200 is connected to the NMS 100 and performs an SNMP communication with the NMS 100. The proxy device 200 is also connected to the router 300f via a protocol other than the protocol used in the IP network, such as the SNMP. In the present embodiment, the proxy device 200 is connected to the router 300f via TELNET, which is one of a command line interface (CLI) via a serial line.

The proxy device 200 is also connected to the routers 300d and 300e via a repeater 500 (such as an access router). Even when the proxy device 200 includes no or little COM port (RS232C port), the proxy device 200 can be connected to many network devices (such as routers 300d and 300e) via the repeater 500 having many COM ports. In the present embodiment, the proxy device 200 and the repeater 500 are connected via the IP network. However, the proxy device 200 and the repeater 500 may be connected via other lines, such as the serial line.

The proxy device 200 instructs the router 300 to output the status information, and receives the status information output from the router 300. Further, the proxy device 200 converts the format of the status information to the MIB format or the MIB-II format, so that the NMS 100 can refer to the status information.

The router 300 is a general router that can execute a command to output the status information on the own status via the RS232C line. A general router can be TELNET-connected with a maintenance terminal via an RS232C port, and outputs the status information in response to the instruction of the maintenance terminal. Accordingly, explanation for the processing in which the router 300 outputs the status information is omitted.

The router 300 has a port for the serial line (RS232C port/COM port) so that the maintenance terminal can be connected via the telnet protocol, in addition to the IP port (RJ45 and the like) for SNMP communication.

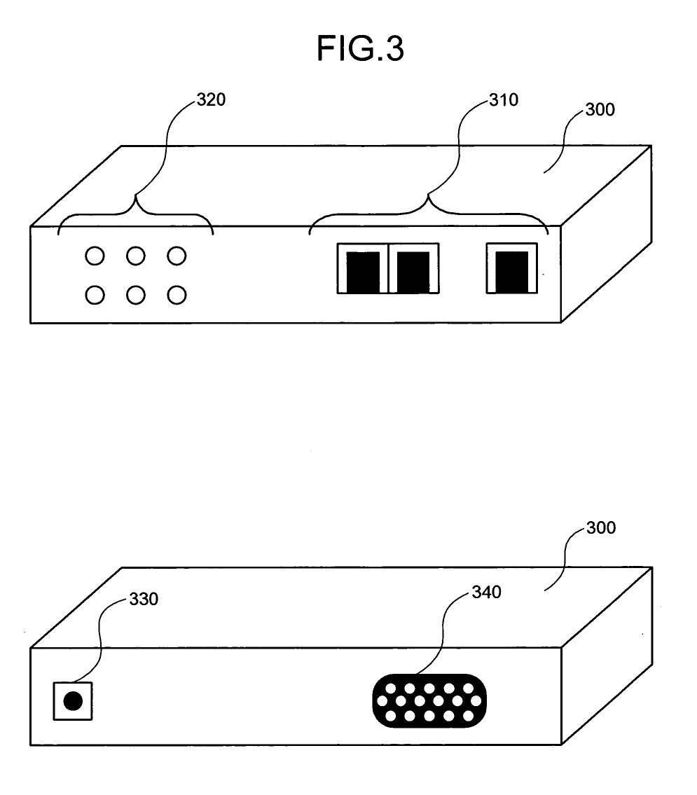

FIG. 3 is an outside view of the router 300. The router 300 has an RJ45 connector 310 for connecting one or a plurality of STP cables for the IP network, and a display section 320 that indicates the status of the line connected to these connectors, on the front face thereof. Further, the router 300 has an RS232C port/COM port 340 for connecting the maintenance terminal, as well as a power supply connector 330 on the back face thereof. The router 300 also has a function of outputting the own status to the maintenance terminal in response to an instruction from the maintenance terminal connected to the RS232C port/COM port 340.

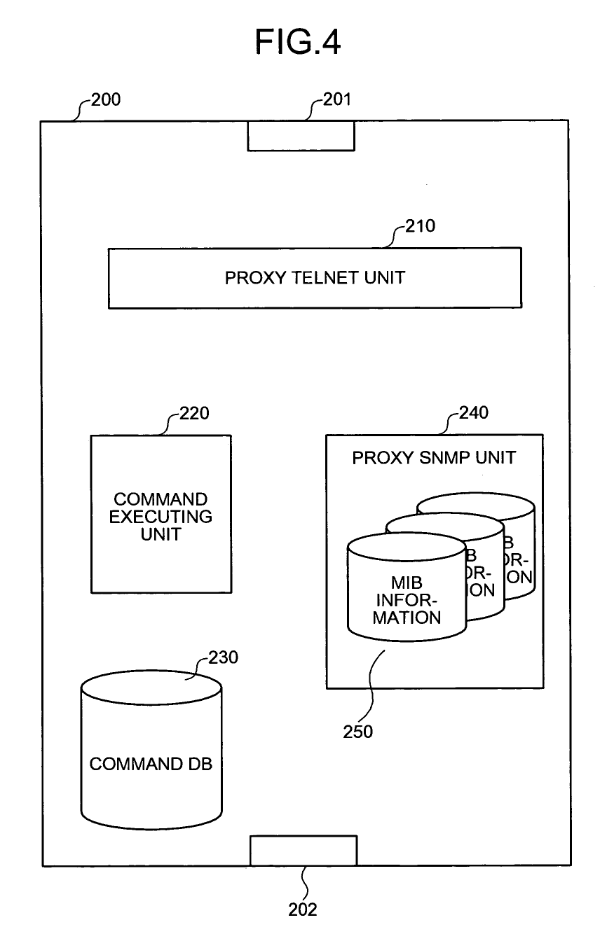

FIG. 4 is a block diagram of the proxy device 200. The proxy device 200 includes an arithmetic unit, a storage unit, an auxiliary storage unit, and an input/output unit (not shown) as in a general computer (personal computer, workstation, server device, and the like).

An IP port 201 is used for connecting the proxy device 200 to the NMS 100 via the SNMP over the IP network. An RS232C port 202 is a port for connecting the proxy device 200 to an RS232C port of the router 300 via the TELNET over the serial line.

The proxy device 200 may include an IP port, instead of the RS232C port 202, for connecting the proxy device 200 to the RS232C port of the router 300 via the repeater 500 as shown in FIG. 2. Alternatively, the proxy device may include both of the RS232C port and the IP port.

A proxy TELNET unit 210 in the proxy device 200 receives an instruction to collect the status of devices to be monitored, from the NMS 100.

A command executing unit 220 in the proxy device 200 determines a device to be monitored, from which the status information is collected through TELNET connection. Further, the command executing unit 220 connects the proxy device 200 to the device to be monitored, which is determined to be an object from which the status information is collected, and instructs the device to output the status information on the status of the own device. The command executing unit 220 further converts the format of the status information to the MIB format or the MIB-II format.

A command database (DB) 230 in the proxy device 200 includes: an IP address for specifying of which router's information the status information is; a file name of a definition file defining commands for logging in to the router 300 and for instructing the router 300 to output the status information; access router information on an access router; and login information indicating where the information for logging in to the router 300 is stored.

A proxy SNMP unit 240 includes MIB information 250 of the router 300, which is converted by the command executing unit 220.

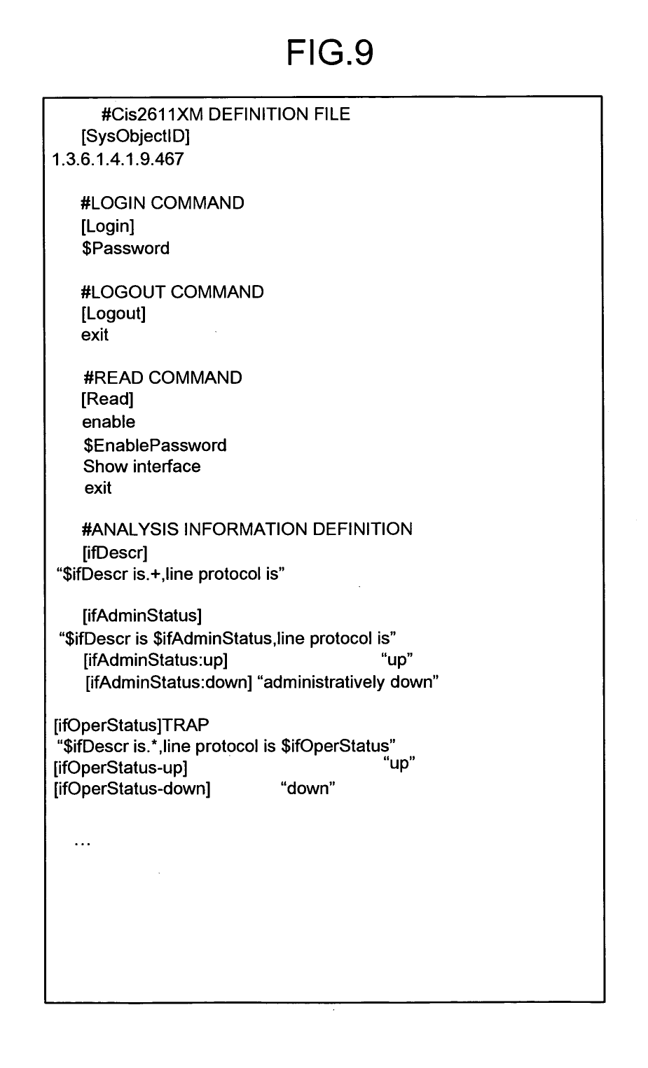

FIG. 9 is a schematic diagram of a definition file [Cis2611_{—}12_{—}1.cfg]. The part shown by [SysObjectID] indicates an ID for uniquely identifying each router 300. The part shown by [#login command] indicates a command to log in to the router 300, upon reception of the login instruction, using a password stored at the address indicated by the login information in the command DB 230. The part shown by [#logout command] indicates a command to finish the processing upon reception of the logout instruction. The part shown by [#read command] indicates a command for causing the router 300 to output the status information by executing a “show interface” command, using the password stored at the address indicated by the login information. The part shown by [#analysis information definition] indicates a definition to convert the format of the status information to the MIB format or the MIB-II format.

The proxy SNMP unit 240 stores the status information converted to the MIB format or the MIB-II format.

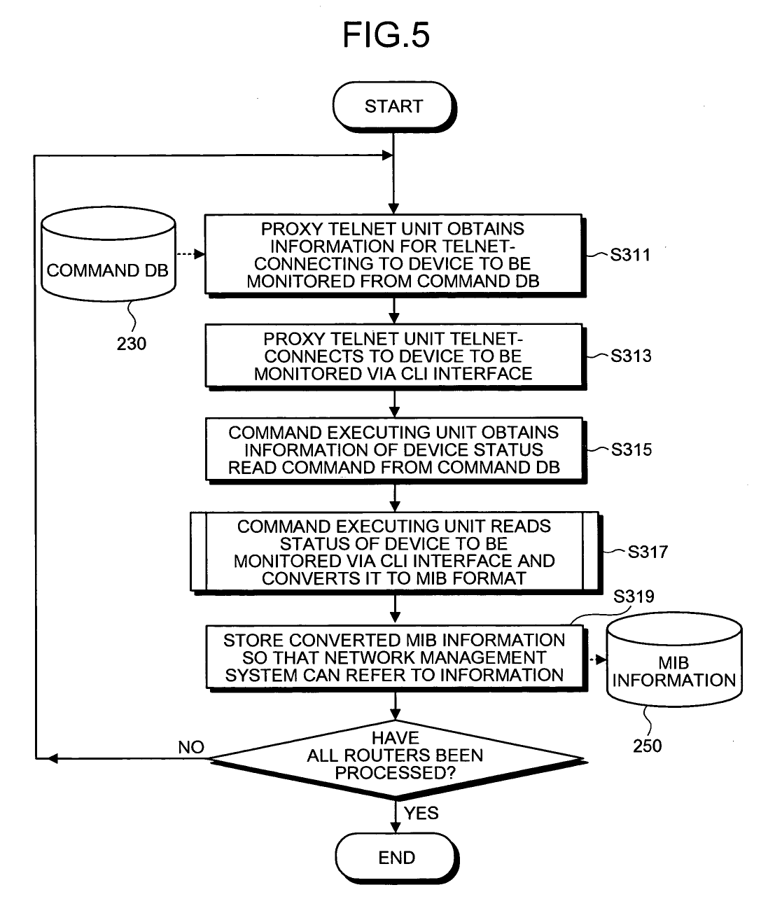

FIG. 5 is a flowchart of a processing performed by the proxy device 200 to cause the routers 300d and 300e, which are connected to the proxy device 200 via the repeater 500, to output the status information.

The timing for outputting the status information of the router 300 is optional. For example, in the present embodiment, it is assumed that the following processing is performed at an interval of 15 minutes.

The access router, which is the repeater 500, has an IP address of [1.2.3.1]. The router 300d is connected to the “0” port of the access router, and the router 300e is connected to the “1” port of the access router.

[Step S311] The proxy TELNET unit 210 refers to the command DB 230 to obtain the definition file in which information for connecting to the routers 300d and 300e is recorded.

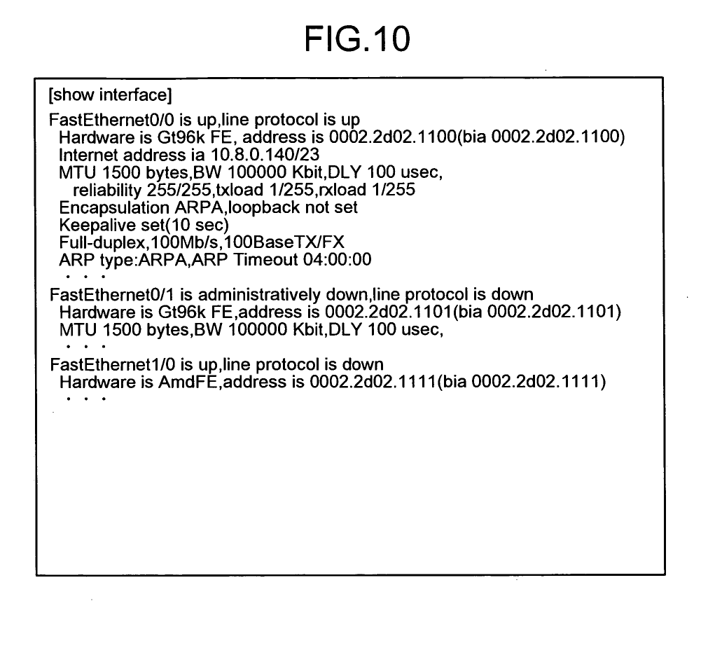

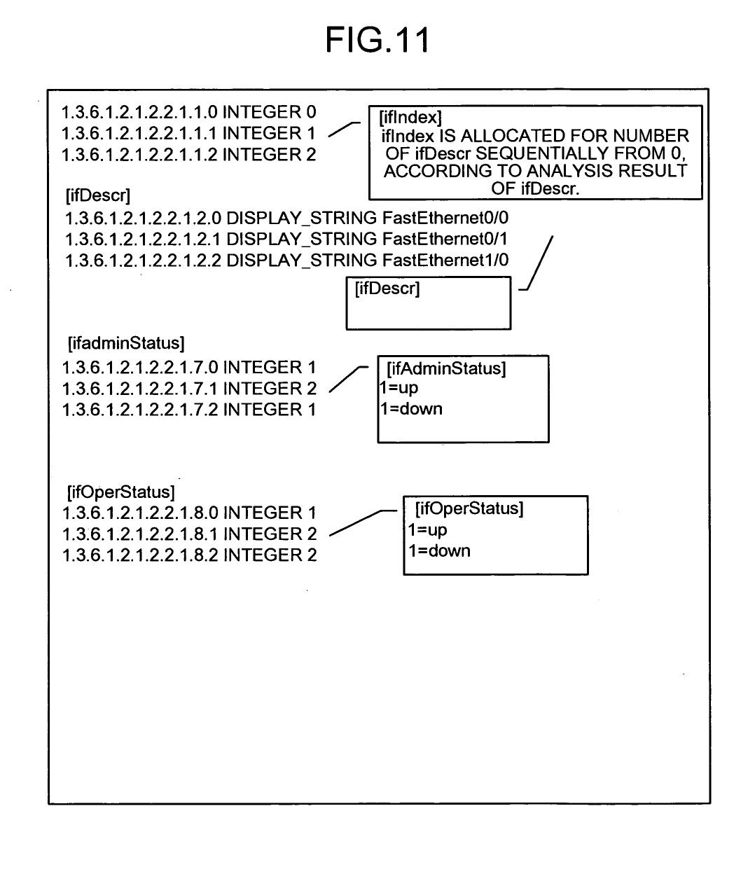

In the present embodiment, it is assumed that the status information of the router 300d connected to the youngest port S0 is output first. Based on the IP address [1.2.3.1], the port [S0], and the access router information in the command DB 230, the definition file [Cis2611_{—}12_{—}1.cfg] associated with [1.2.3.1/S0] is specified.

[Step S313] The proxy TELNET unit 210 logs in to the router 300d according to the login information held in the command DB 230. More specifically, the proxy TELNET unit 210 issues the #login command defined in the definition file Cis2611Xm shown in FIG. 9. A password described in a /pass/enablepass file (not shown) is used to log in to the router 300d.

[Step S315] The command executing unit 220 causes the router 300d to output the status information according to the read command in the command DB 230. After becoming a user having an authority of executing the read command based on the information in the [#read command] section in the definition file shown in FIG. 9, the router 300d executes the [show interface] command, which is a command to output the status information of the own status. The router 300d executes the instructed command, and outputs the status information shown in FIG. 10.

[Step S317] The command executing unit 220 converts the status information output from the router 300d at step S315 to the MIB format, according to the condition described in the definition file. More specifically, the information shown in FIG. 10 is converted to the MIB format shown in FIG. 11, according to the condition indicated by [#analysis information definition] shown in FIG. 9. The dialog balloons shown in FIG. 11 are provided for the convenience of explanation.

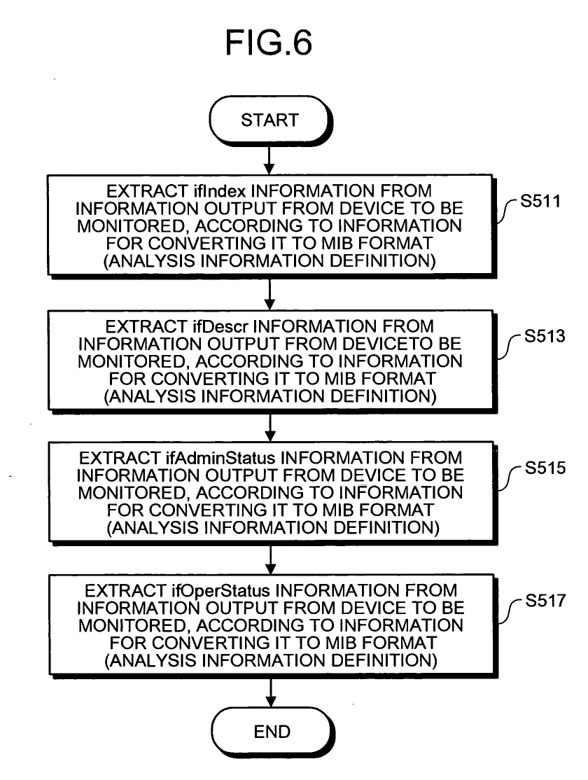

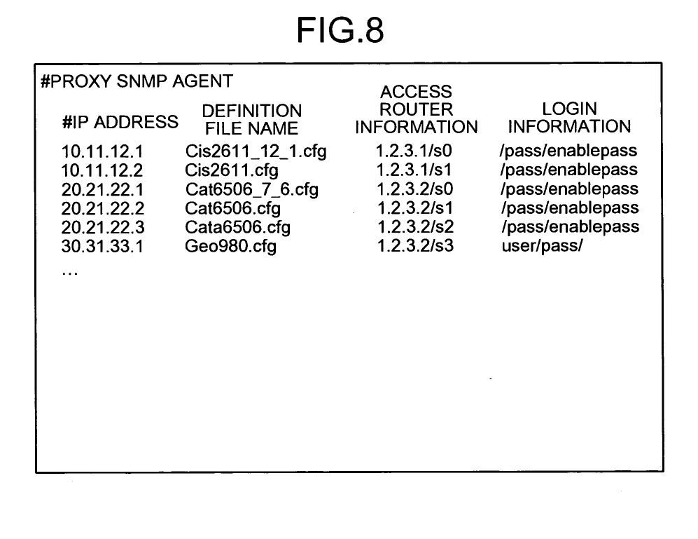

The processing at step S317 will be explained with reference to FIGS. 6, 10, and 11. In the present embodiment, as an example of generating the MIB information from the information output by the router at step S315, an example of generating items of [ifindex], [ifDescr], [ifAdminStatus], and [ifOperStatus], which are items in a part of the MIB information, will be explained.

[Step S511] The command executing unit 220 generates information of ifindex, which is an item in the MIB information, based on the information indicating the status of the own device output by the router. In the present embodiment, a head portion of a line including [is] and [line protocol is], defined by [ifDescr] in the [#analysis information definition], is extracted as a port. In present the embodiment shown in FIG. 6, three ports, that is, [FastEthernet 0/0] ([Ethernet] is a registered trademark), [FastEthernet 0/1] ([Ethernet] is a registered trademark), and [FastEthernet 1/0] ([Ethernet] is a registered trademark) are extracted. [1.3.6.1.2.1.2.2.1.1.0] and the like described at the left end in FIG. 11 are object identification (OID), and are values defined by the regulation of the RFC-1156, and hence, the explanation thereof is omitted.

[Step S513] The command executing unit 220 allocates ifindex for the number of ports obtained at step S511. In the present embodiment, since three ports are detected at step S511, the command executing unit 220 allocates three ifindex (0 to 2) sequentially from 0.

[Step S515] The command executing unit 220 generates the information of ifAdminStatus, which is an item in the MIB information, based on the information indicating the status of the own device output by the router. In the present embodiment, if a word located at a position surrounded by [is] and [line protocol is] is [up], [1] is generated, and if the word is [down], [2] is generated, as the MIB information of ifAdminStatus.

[Step S517] The command executing unit 220 generates the information of ifOperStatus, which is an item in the MIB information, based on the information indicating the status of the own device output by the router. In the present embodiment, if a word following [is] and [line protocol is] is [up], [1] is generated, and if the word is [down], [2] is generated, as the MIB information of ifOperStatus.

[Step S319] The command executing unit 220 stores the MIB information generated based on the information indicating the status of the own device output by the router at step S317, in a format which can be determined of which network device the MIB information is. In the present embodiment, the command executing unit 220 stores the information relating to the device (router 300d) connected to the 0th port of the access router 1.2.3.1, (repeater 500), in a file name of [10.11.12.1] in the proxy device, by referring to the IP address section in the command DB shown in FIG. 8. Upon reception of a request to refer to the status information relating to the IP address 10.11.12.1 indicating the router 300d from the NMS 100, the proxy SNMP unit 240 makes the NMS 100 refer to the information of the file [10.11.12.1].

Since the proxy device 200 performs the processing described above, the NMS 100 can refer to the MIB information of the router 300d, which is a network device not connected to the IP network and hence incapable of using the SNMP.

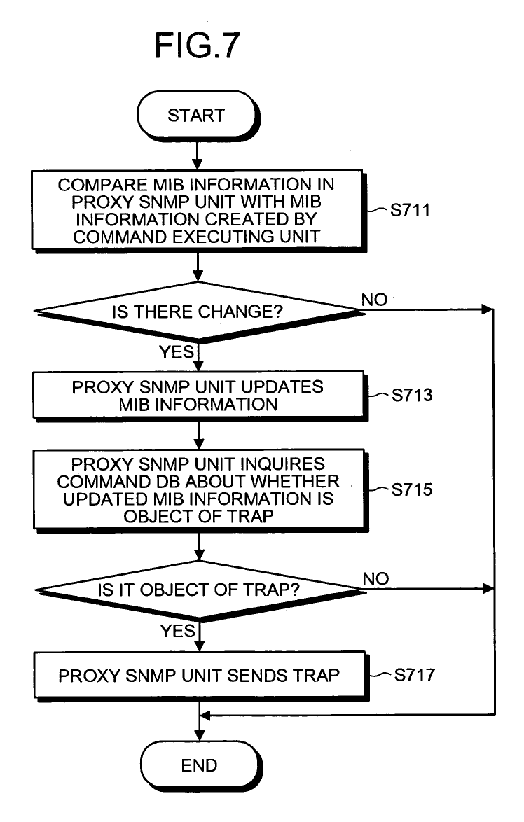

In the example shown in FIGS. 5 and 6, the MIB information is updated at a predetermined interval. However, as shown in FIG. 7, the MIB information may be updated only when there is any change in the MIB information, and the NMS 100 may be informed of the change only when there is any change in the MIB information.

[Step S711] The proxy SNMP unit 240 compares the MIB information 250 stored therein, which is previously generated by the command executing unit 220, with the MIB information currently generated by the command executing unit 220, which is shown in FIG. 11.

[Step S713] When the MIB information currently generated by the command executing unit 220 is different from the MIB information 250 stored therein at step S711 (Step S711: Yes), the proxy SNMP unit 240 substitutes the MIB information stored therein by the MIB information currently generated by the command executing unit 220.

[Step S715] The proxy SNMP unit 240 determines whether the router 300 to be monitored, whose MIB information 250 has been changed, is a monitoring object of the TRAP based on whether there is a description of “TRAP” in the [ifOperStatus] section of the [#analysis information definition] in the definition file [Cis2611_{—}12_{—}1.cfg]. In the present embodiment, since there is the description of “TRAP” in the [ifOperStatus] section of the [#analysis information definition] in the definition file [Cis2611_{—}12_{—}1.cfg], it is determined that the router 300 is an object of TRAP.

[Step S717] When the proxy SNMP unit 240 determines at step S715 that the router 300 to be monitored, whose MIB information 250 has been changed, is the monitoring object of the TRAP (step S715: Yes), the proxy SNMP unit 240 sends TRAP to the NMS 100.

Since the proxy device 200 functions as described above, the NMS 100 that performs network monitoring using the SNMP can also manage the network device, which cannot be connected due to unavailability of unused port of the IP network for connection, by using the information of the MIB or the MIB-II.

In the present embodiment, the proxy device 200 and the router 300 to be monitored are connected through the TELNET via the RS232C port/COM port to the maintenance terminal. However, the present invention is not limited thereto.

In the present embodiment, there is one NMS 100 and one router 300 to be monitored that are connected to the proxy device 200. However, the NMS 100 and the router 300 to be monitored may be provided in a plurality of numbers.

In the present embodiment, the proxy device 200 itself includes the command DB or holds the collected MIB information, but these may be held externally via a line and the like.

The processing for converting the status information to the MIB information, which is explained in the present embodiment, is an example, and the conversion method is not limited to the method described herein.

The NMS that monitors the network with the SNMP can manage also a network device, which cannot be connected due to unavailability of unused port of the IP network for connection, by using the MIB or MIB-II information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer-readable recording medium that stores a computer program that causes a computer that provides status information on a status of a target device to a network management system to execute:
requesting the target device to output the status information; and
converting a format of the status information output from the target device to another format which can be managed by the network management system.

2. The computer-readable recording medium according to claim 1, wherein the computer program further causes the computer to execute referring to access information for an access to the target device, wherein
the requesting includes requesting the status information to the target device based on the access information.

3. The computer-readable recording medium according to claim 1, wherein the computer program further causes the computer to execute referring to conversion information for converting the format of the status information, wherein
the requesting includes requesting the status information to the target device based on the access information.

4. The computer-readable recording medium according to claim 1, wherein the requesting includes requesting the target device to output the status information via a serial line.

5. The computer-readable recording medium according to claim 1, wherein the computer program further causes the computer to execute storing the status information converted so that the network management system can identify the status information of each target device.

6. The computer-readable recording medium according to claim 1, wherein the computer program further causes the computer to execute:
determining whether there is a change in the status information output from the target device; and
notifying the network management system of the change when it is determined that there is the change in the status information.

7. The computer-readable recording medium according to claim 6, wherein
the determining includes determining whether there is the change in the status information output from a specific target device, and
the notifying includes notifying the network management system of the change when it is determined that there is the change in the status information output from the specific target device.

8. An apparatus that provides status information on a status of a target device to a network management system, the apparatus comprising:
a request unit that requests the target device to output the status information; and
a converting unit that converts a format of the status information output from the target device to another format which can be managed by the network management system.

9. The apparatus according to claim 8, wherein the request unit requests the target device to output the status information via a serial line.

10. The apparatus according to claim 8, further comprising:
a first storage unit that stores access information for an access to the target device; and
a second storage unit that stores conversion information for converting the format of the status information.

11. A method for providing status information on a status of a target device to a network management system, the method comprising:
requesting the target device to output the status information; and
converting a format of the status information output from the target device to another format which can be managed by the network management system.
